(19) United States
(12) Patent Application Publication
(10) Pub. No.: US 2006/0017852 A1
(43) Pub. Date: Jan. 26, 2006

(54) Information processing apparatus and display control method

(76) Inventor: Tsutomu Iwaki, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/185,817

(22) Filed: Jul. 21, 2005

(30) Foreign Application Priority Data
Jul. 21, 2004 (JP) P2004-213617

(51) Int. Cl. H04N 11/20

(52) U.S. Cl. 348/581; 348/448

(57) ABSTRACT

An information processing apparatus including: a display being capable of displaying moving image data having a predetermined outer peripheral area and having a first resolution; a moving image data generating section that generates the moving image data having a second resolution; a first scaling section that performs scaling processing so that an area except the predetermined outer peripheral area in the moving image data having the second resolution substantially matches the first resolution; and a displaying section that causes the display to display the area except the predetermined outer peripheral area in the moving image data subjected to the scaling processing by the first scaling section.

### CROSS-REFERENCE TO RELATED APPLICATIONS

This application is based upon and claims the benefit of priority from the prior Japanese Patent Application No. 2004-213617, filed on Jul. 21, 2004; the entire contents of which are incorporated herein by reference.

### BACKGROUND OF THE INVENTION

1. Field of the Invention

This invention relates to an information processing apparatus that can display image data on a display and a display control method for use in the apparatus.

2. Description of the Related Art

When a TV broadcast video signal is displayed on a screen of a CRT TV receiver, generally the video signal contains an image area on which viewer eyes fall and a control area called an overscan area existing in the surroundings of the image area and existing in an area on which viewer eyes do not fall.

To display TV broadcast video using a display different in standard from a CRT TV receiver, the user eyes may fall on the overscan area that is obtrusive for the viewer.

For example, in a personal computer containing a TV tuner, etc., not only graphics (still image), but also video (moving image) of TV broadcast, etc., can be recorded on a record medium and can be reproduced on a screen of an LCD (Liquid Crystal Display). When video produced assuming that the video is viewed with a CRT TV receiver, etc., is taken into the personal computer, the video is recorded and reproduced also containing the overscan area and when the video is output to the LCD, the user eyes fall on the overscan area in the form of noise, etc., and the user feels displeasure.

To display a video signal in a letter box format containing a no-image portion providing no image information on a screen although it differs from the overscan area, a related art of suppressing display of the no-image portion is known. For example, JP-A-10-233976 discloses a TV receiver including vertical scaling up means for scaling up video signal in the vertical direction and horizontal scaling up means for scaling up video signal in the horizontal direction so that the no-image portion of the video signal in the letter box format is not viewed from the display.

### BRIEF SUMMARY OF THE INVENTION

However, the related art disclosed in JP-A-10-233976 is intended for a TV receiver for receiving TV video and is not intended for an information processing apparatus that can display both a moving image and a still image like the personal computer described above. Thus, each of a moving image having an overscan area and a still image having no overscan area cannot be displayed in the appropriate form on the LCD of the personal computer, etc.

It is therefore an object of the invention to provide an information processing apparatus and a display control method capable of displaying image data on a display in the appropriate form.

### BRIEF DESCRIPTION OF THE DRAWINGS

FIG. 1 is a perspective view showing the appearance of a computer according to one embodiment of the invention;

FIG. 2 is a block diagram showing the system configuration of the computer in FIG. 1;

FIG. 3 is a drawing to describe a window mode;

FIG. 4 is a drawing to describe a full screen mode;

FIGS. 5A and 5B are drawings showing a screen example for performing alpha blending processing of video information (moving image data) and graphics information (still image data);

FIG. 6 is a block diagram showing the configuration of a high quality video engine installed in the computer in FIG. 1;

FIG. 7 is a drawing showing an example of scaling processing for displaying an image on an LCD screen as video information (moving image data) and graphics information (still image data) are alpha-blended;

FIG. 8 is a drawing showing another example of scaling processing for displaying an image on an LCD screen as video information (moving image data) and graphics information (still image data) are alpha-blended;

FIG. 9 is a drawing showing an example of an interface for appropriately displaying video information (moving image data) and graphics information (still image data) on the LCD screen;

FIG. 10 is a drawing showing an example of a setting screen provided by an application for enabling the user to specify the display suppression range (containing an overscan area) on the LCD screen; and

FIG. 11 is a flowchart showing a procedure of display control processing executed in the computer in FIG. 1.

### DETAILED DESCRIPTION OF THE INVENTION

Referring now to the accompanying drawings, there is shown an embodiment of the invention.

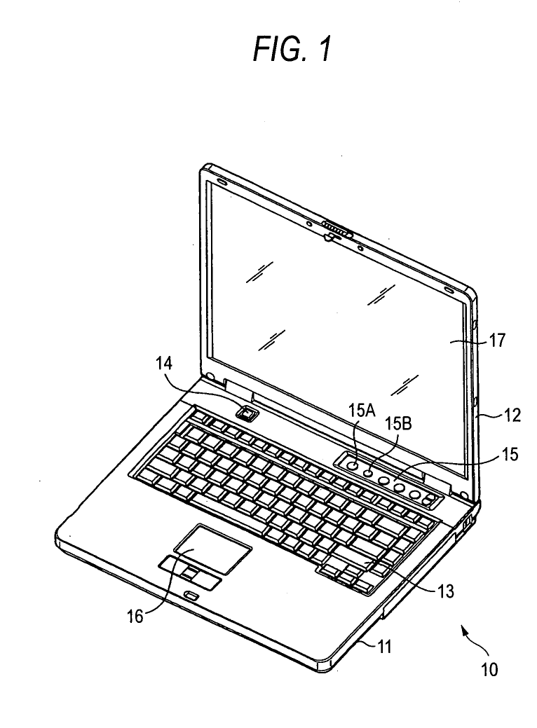

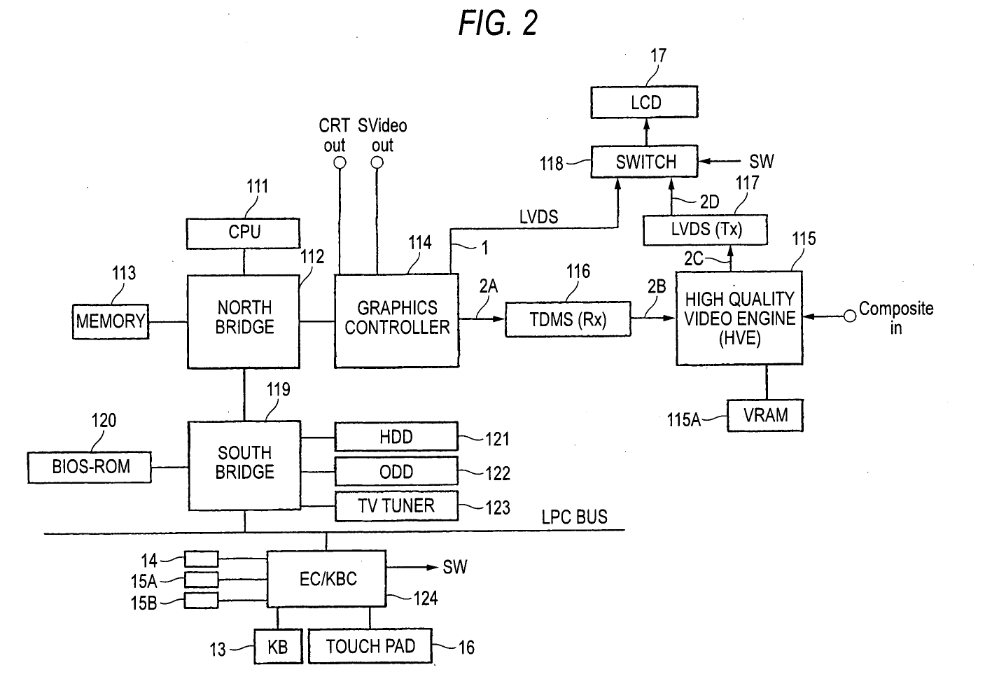

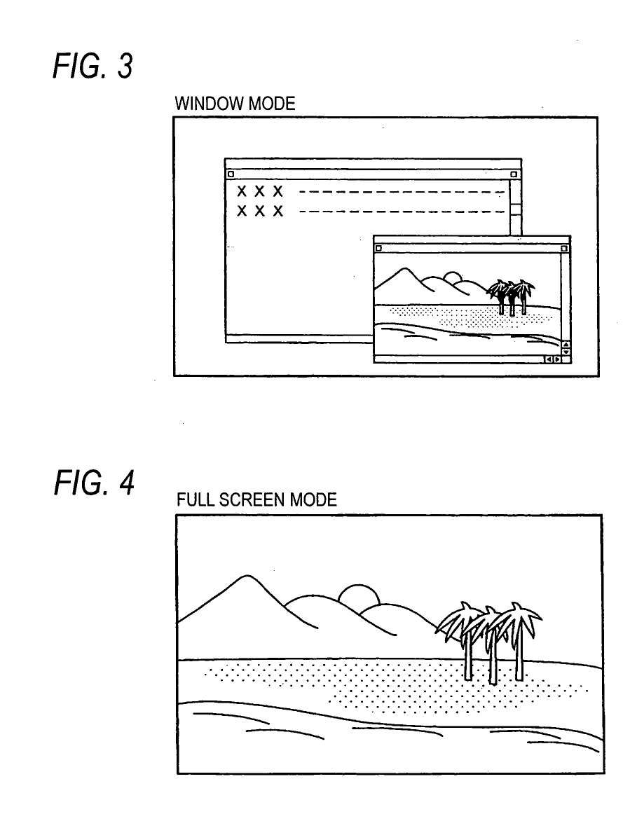

To begin with, the configuration of an information processing apparatus according to one embodiment of the invention will be described with reference to FIGS. 1 and 2. The information processing apparatus is implemented as a notebook personal computer 10, for example.

FIG. 1 is a front view of the notebook personal computer 10 with a display unit thereof open. The computer 10 is made up of a computer main unit 11 and a display unit 12. A display implemented as an LCD (Liquid Crystal Display) 17 is built in the display unit 12, and a display screen of the LCD 17 is positioned almost in the center of the display unit 12.

The display unit 12 is attached to the computer main unit 11 for rotation between an open position and a closed position of the computer. The computer main unit 11 has a thin box-shaped cabinet on which a keyboard 13, a power button 14 for turning on/off power of the computer 10, an input operation panel 15, a touch pad 16, and the like are placed.

The input operation panel 15 is an input unit for inputting an event corresponding to the pressed button and includes a plurality of buttons for starting a plurality of functions. The buttons also contain a TV start button 15A and a DVD/CD start button 15B. The TV start button 15A is a button for reproducing TV broadcast program data. When the user presses the TV start button 15A, an application program for reproducing TV broadcast program data is started automatically. The DVD/CD start button 15B is a button for reproducing video content recorded on a DVD or a CD. When the user presses the DVD/CD start button 15B, an application program for reproducing video content is started automatically.

To display moving image data such as TV broadcast program data or video content on the LCD 17 with high image quality, the computer 10 of the embodiment is provided with a function of automatically putting the moving image data into high image quality when the moving image data is reproduced.

Next, the system configuration of the computer 10 will be described with reference to FIG. 2.

As shown in FIG. 2, the computer 10 includes a CPU 111, a north bride 112, main memory 113, a graphics controller 114, a high quality video engine (HVE) 115, a TMDS (Rx) processing section 116, an LVDS (Tx) processing section 117, a switch 118, a south bridge 119, a BIOS-ROM 120, a hard disk drive (HDD) 121, an optical disk drive (ODD) 122, a TV tuner 123, an embedded controller/keyboard controller IC (EC/KBC) 124, and the like.

The CPU 111 is a processor provided for controlling the operation of the computer 10 and executes the operating system (OS) and various application programs loaded into the main memory 113 from the hard disk drive (HDD) 121.

The OS has a window system for displaying a plurality of windows on a display screen.

Moving image data (for example, TV broadcast program data received by the TV tuner 123, video content recorded on a storage medium such as a DVD or an HDD, etc.,) is displayed in a window corresponding to a video reproduction application program for reproducing the moving image data. In this case, for example, the window corresponding to the video reproduction application program is placed on a desktop screen and the moving image data is displayed in the window (window mode).

The computer 10 can also display the moving image data on the display screen of the LCD 17 in a full screen mode. In the full screen mode, basically the moving image data is displayed in almost all area on the display screen, as shown in FIG. 4. In this case, the desktop screen and the window corresponding to any application program other than the video reproduction application program are not displayed as a rule. A menu bar, etc., of the window corresponding to the video reproduction application program is not displayed either and the moving image data is displayed in almost all area on the display screen.

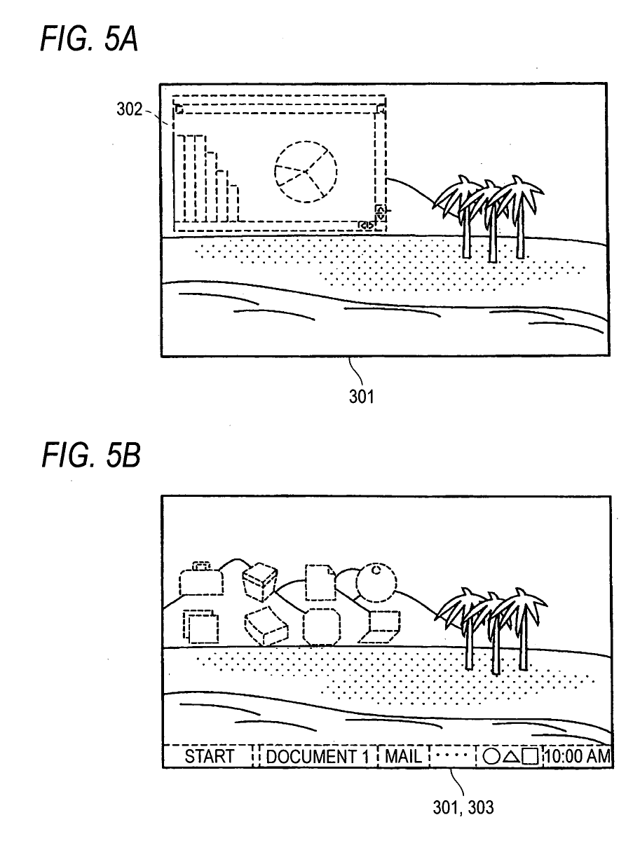

However, the moving image data may be subjected to blending (for example, alpha blending) processing of superposing graphics data (still image data), for example, as shown in FIGS. 5A and 5B. The display screen shown in FIG. 5A is a screen displaying video provided by performing blending processing of still image data 302 into moving image data 301 on the LCD 17. In this case, the size of the still image data 302 is smaller than that of the moving image data 301.

Video provided by performing blending processing of still image data 303 of substantially the same size as the moving image data 301 into the moving image data 301 may be displayed on the LCD 17. FIG. 5B shows an example of the screen.

The CPU 111 also executes system BIOS (Basic Input Output System) stored in the BIOS-ROM 120. The system BIOS is a program for controlling hardware.

The north bride 112 is a bridge device for connecting a local bus of the CPU 111 and the south bridge 119. The north bride 112 contains a memory controller for controlling access to the main memory 113. The north bride 112 also has a function of executing communications with the graphics controller 114 via an AGP (Accelerated Graphics Port) bus, etc.

The graphics controller 114 is a display controller for controlling the LCD 17 used as a display monitor of the computer 10. The graphics controller 114 has video memory (VRAM) and generates a video signal for forming a display image displayed on the LCD 17 from display data drawn in the video memory (VRAM) by OS/application program. The display image displayed on the LCD 17 usually is made up of the image of the desktop screen and the image of each window placed on the desktop screen. However, to display the moving image data in the full screen mode, the display image displayed on the LCD 17 usually is implemented as the image of the moving image data. Therefore, to display the moving image data in the full screen mode, the video signal for forming the display image of the moving image data is output from the graphics controller 114.

The video signal generated by the graphics controller 114 is output to a line 1 and a line 2A. The video signal output to the line 1 is implemented as an 18-bit signal in LVDS (Low Voltage Differential Signaling) format, for example. The video signal output to the line 2A is implemented as a 24-bit signal in TMDS (Transition Minimized Differential Signaling) format, for example. The graphics controller 114 also has an interface for outputting an analog video signal to an external CRT (Cathode Ray Tube) and an interface for outputting an analog video signal through an S video terminal to an external machine.

Further, the graphics controller 114 also has a scaling function to change the resolution and the aspect ratio of still image data of graphics, etc. When still image data of graphics, etc., needs to be blended (for example, alpha-blended) into moving image data, the graphics controller 114 can send the still image data to the high quality video engine (HVE) 115 together with the moving image data.

The TMDS (Rx) processing section 116 converts the 24-bit signal in the TMDS format sent from the graphics controller 114 via the line 2A into a 24-bit RGB digital signal and sends the 24-bit RGB digital signal to the high quality video engine (HVE) 115 via a line 2B.

The high quality video engine (HVE) 115 is a video processing controller for executing video processing to put the video signal generated by the graphics controller 114 into high image quality, which will be hereinafter referred to as image quality correction processing. The high quality video engine (HVE) 115 has video memory (VRAM) 115A.

The image quality correction processing is executed in the video memory (VRAM) 115A. The image quality correction processing is video processing dedicated to a moving image to put a moving image into high image quality and is executed to display a smooth high-quality moving image on the LCD 17. In the image quality correction processing, processing of contrast adjustment, brightness adjustment, hue adjustment, saturation adjustment, gamma correction, white balance adjustment, intensity adjustment, sharpness adjustment, edge enhancement, response speed improvement, etc., can be performed to improve the image quality of a moving image.

The high quality video engine (HVE) 115 can also perform the image quality correction processing for a video signal input from an external video machine through a composite input terminal.

The video signal subjected to the image quality correction by the high quality video engine (HVE) 115 is sent via a line 2C to the LVDS (Tx) processing section 117.

The LVDS (Tx) processing section 117 converts the RGB digital signal subjected to the image quality correction output from the high quality video engine (HVE) 115 into a signal in LVDS (Low Voltage Differential Signaling) format and outputs the signal in the LVDS format to a line 2D. To use an external LCD panel, a connection terminal is connected to output of the LVDS (Tx) processing section 117.

Further, the high quality video engine (HVE) 115 also has a scaling function to change the resolution and the aspect ratio of the video signal. The video signal is scaled after image quality correction processing of the video signal is executed. The moving image can be displayed with higher image quality by performing image quality correction processing for pre-scaled data and scaling the video signal subjected to the image quality correction processing rather than by performing image quality correction processing for the post-scaled video signal.

The switch 118 functions as a selector for selectively outputting one of a video signal generated by the graphics controller 114 and a video signal subjected to image quality correction by the high quality video engine (HVE) 115 to the LCD 17. The switch 118 has a first input terminal connected to the line 1, a second input terminal connected to the line 2D, and an output terminal connected to the LCD 17. The switch 118 selects one of the first input terminal and the second input terminal in response to a switch control signal SW supplied from the EC/KBC 124 and connects the selected input terminal to the output terminal.

In the embodiment, the switch 118 makes it possible to use the following two display control modes:

(1) Normal mode: In the normal mode, the video signal from the graphics controller 114 is sent to the LCD 17 not via the high quality video engine (HVE) 115. The normal mode is used when the display image displayed on the LCD 17 contains a still image, for example.

(2) High image quality mode: In the high image quality mode, the video signal from the graphics controller 114 is sent to the LCD 17 via the high quality video engine (HVE) 115. The high image quality mode is used to display moving image data (containing the case where still image data is blended) in the full screen mode, for example.

However, the specific example of switching of the switch 118 described above is only one example, and the high image quality mode may be adopted at all times regardless of a moving image or a still image.

The south bridge 119 controls devices on an LPC (Low Pin Count) bus. The south bridge 119 contains an IDE (Integrated Drive Electronics) controller for controlling the HDD 121 and the ODD 122. Further, the south bridge 119 also has a function to control the TV tuner 123 and a function to control access to the BIOS-ROM 120.

The optical disk drive (ODD) 122 a drive unit for driving a storage medium such as a DVD or a CD storing video content. The TV tuner 123 is a receiver for receiving broadcast program data of a TV broadcast program, etc.

The embedded controller/keyboard controller IC (EC/KBC) 124 is a one-chip microcomputer into which an embedded controller for power management and a keyboard controller for controlling the keyboard (KB) 13 and the touch pad 16 are integrated. The embedded controller/keyboard controller IC (EC/KBC) 124 has a function of turning on/off the power of the computer 10 in response to user's operation of the power button 14.

Further, the embedded controller/keyboard controller IC (EC/KBC) 124 has a function of setting and changing the rightness of illumination (backlight, etc.,) of the LCD 17, a function of communicating with the high quality video engine (HVE) 115 via the I2C bus, and a function of supplying the above-mentioned switch control signal SW to the switch 118.

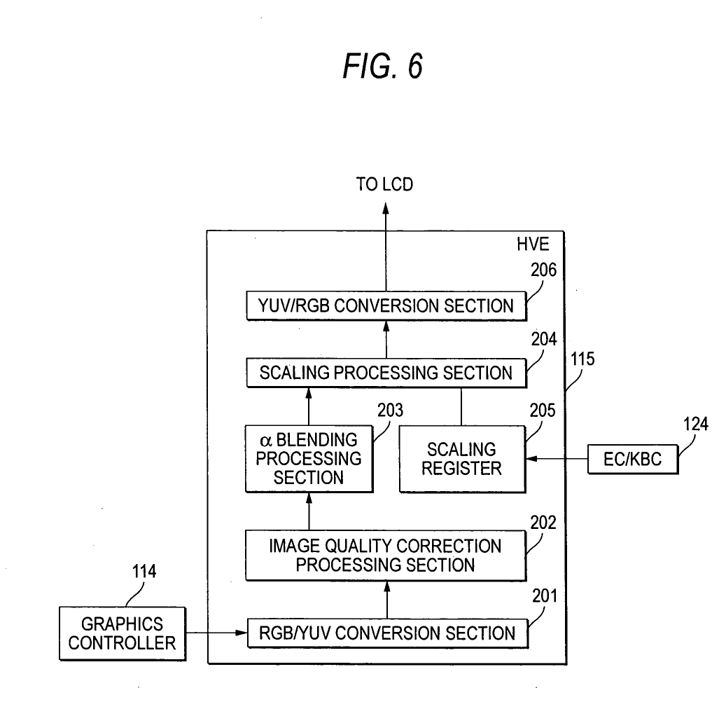

Next, a configuration example of the high quality video engine (HVE) 115 will be described with reference to FIG. 6.

As shown in the figure, the high quality video engine (HVE) 115 includes an RGB/YUV conversion section 201, an image quality correction processing section 202, an alpha blending processing section 203, a scaling processing section 204, a scaling register 205, a YUV/RGB conversion section 206, and the like. The placement relationships among the elements may be changed whenever necessary.

The RGB/YUV conversion section 201 converts a video signal transmitted from the graphics controller 114 through the TMDS (Rx) processing section 116 from the 24-bit RGB signal into a 24-bit YUV signal.

The image quality correction processing section 202 performs operation processing on the YUV signal for image quality correction (contrast adjustment, brightness adjustment, hue adjustment, saturation adjustment, gamma correction, white balance adjustment, intensity adjustment, sharpness adjustment, edge enhancement, response speed improvement, etc.).

When still image data of graphics, etc., is input together with moving image data, the alpha blending processing section 203 performs blending processing of the still image data into the moving image data based on a variable representing transparency (alpha). The variable (alpha) determines the transparency of the still image data blended into the moving image data. The alpha blending processing section 203 is not limited to placement between the image quality correction processing section 202 and the scaling processing section 204. For example, the alpha blending processing section 203 may be placed following the scaling processing section 204.

The scaling processing section 204 performs scaling processing of the YUV signal subjected to image quality correction in accordance with scaling parameter information set in the scaling register 205. The scaling processing is processing to change the size (resolution) of moving image data. As the scaling processing is performed, the size (resolution) of the moving image data is changed to the size suited for the size of the display screen of the LCD 17 (panel resolution). The scaling parameter information contains the resolution of moving image data (and still image data), the aspect ratio of moving image data (and still image data), the panel resolution of the LCD 17, the enlargement ratio or reduction ratio of moving image data (and still image data), etc. The panel resolution of the LCD 17 may be not only the physical resolution, but also the screen resolution set by the user.

The scaling parameter information stored in the scaling processing section 204 can be set and changed by the EC/KBC 124. When moving image data and still image data are input, basically scaling processing based on the common enlargement ratio or reduction ratio to both is performed, but change may be made so that scaling processing based on different enlargement ratios or reduction ratios is performed.

The YUV/RGB conversion section 206 converts the scaled video signal from the YUV signal into an RGB signal. This RGB signal is sent to the LCD 17.

In addition, a mask processing section for performing masking processing for the surrounding portion of the moving image data input to the high quality video engine (HVE) 115 may be provided. The mask processing section may be contained in the scaling processing section 204. In this case, the mask processing section also includes a register for storing masking parameter information indicating the image range for masking, and the configuration is set so that the masking parameter information can be set and changed by the EC/KBC 124.

The processing to put into high image quality, performed by the processing sections described above may be performed for the RGB video signal rather than for the YUV video signal.

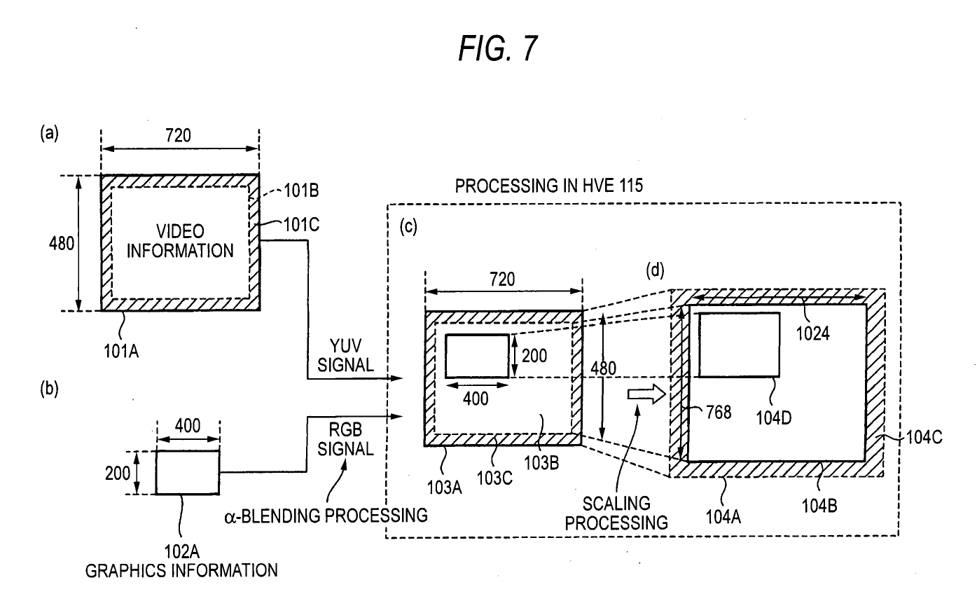

Next, an example of scaling processing for displaying an image on the screen of the LCD 17 as video information (moving image data) and graphics information (still image data) are alpha-blended will be described with reference to FIG. 7.

It is assumed that the screen (panel) of the LCD 17 has a first resolution (1024×768).

As shown in (a) in FIG. 7, video information received by the TV tuner 123 or video information 101A stored in a storage medium such as a DVD has a second resolution (720×480), for example. The video information 101A contains viewer-oriented information (for example, actual content, etc.,) 101B and an overscan area 101C surrounding the viewer-oriented information 101B. The video information is sent to the high quality video engine (HVE) 115 through the graphics controller 114 as a YUV signal with the second resolution (720×480) intact.

On the other hand, as shown in (b) in FIG. 7, graphics information 102A generated in the graphics controller 114 as a third resolution (400×200), for example. The graphics information 102A having the third resolution (400×200) is sent to the high quality video engine (HVE) 115 as an RGB signal.

As shown in (c) in FIG. 7, the high quality video engine (HVE) 115 performs alpha blending processing of the video information 101A having the second resolution (720×480) and the graphics information 102A having the third resolution (400×200). Video information 103A with a still image 103B subjected to alpha blending processing is generated in an area except an overscan area 103C.

As shown in (d) in FIG. 7, the video information 103A generated by the alpha blending processing is scaled up by a scaling processing function of the high quality video engine (HVE) 115 at the enlargement ratio satisfying the condition described below to generate video information 104A. The resolution of the video information 104A after scaled up becomes larger than the resolution (1024×768) of the screen of the LCD 17. As graphics information 103B is scaled up, graphics information 104D contained in the video information 104A after scaled up is generated.

The enlargement ratio satisfying the condition to scale up the video information 103A to the video information 104A is the enlargement ratio for causing an overscan area 101C in the video information 104A to overflow the resolution of the LCD screen. That is, it is the enlargement factor at which the size of an area 104B which is not the overscan area 104C in the video information 104A roughly matches the size of the screen of the LCD 17. As the video information 103A is scaled up to the video information 104A at the enlargement ratio, the viewer eyes do not fall on the overscan area 104C and fall on the area 104B which is not the overscan area 104C in the video information.

In the example in (d) in FIG. 7, the size of the still image 104D after scaled up is smaller than the size of the screen of the LCD 17 (1024×768), but scaling processing may be performed so that the size of the still image 104D after scaled up roughly matches the size of the screen of the LCD 17. In this case, for example, the reduction ratio in the scaling processing described in (b) in FIG. 7 may be adjusted or the position of the still image relative to the moving image in the alpha blending processing may be adjusted. The enlargement ratio in the scaling processing described in (d) in FIG. 7 may be adjusted.

The size of the overscan area is not definitely determined; it is desirable that the width of the area off the screen on which the viewer eyes do not fall should be set to about 20 dots in the horizontal direction and about 40 lines in the vertical direction, for example.

The image data generated by performing the processing in FIG. 7 is displayed on the LCD 17 in the form as shown above in FIG. 5A, for example.

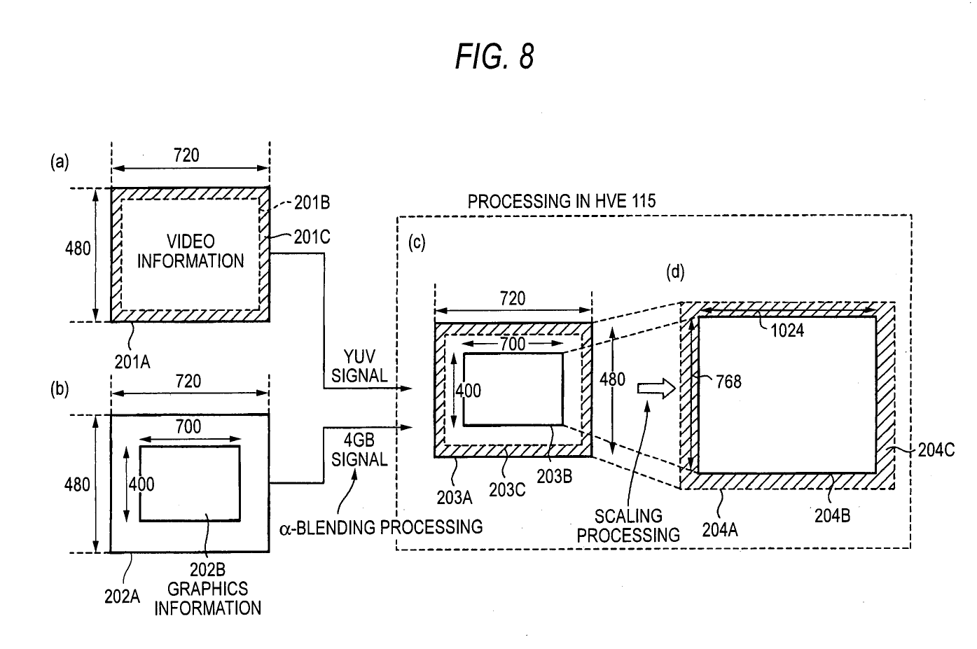

Next, an example of scaling processing for displaying an image on the screen of the LCD 17 as video information (moving image data) and graphics information (still image data) are alpha-blended will be described with reference to FIG. 8.

It is assumed that the screen (panel) of the LCD 17 has the first resolution (1024×768).

As shown in (a) in FIG. 8, video information received by the TV tuner 123 or video information 201A stored in a storage medium such as a DVD has the second resolution (720×480), for example. The video information 201A contains viewer-oriented information (for example, actual content, etc.,) 201B and an overscan area 201C surrounding the viewer-oriented information 201B. The video information is sent to the high quality video engine (HVE) 115 through the graphics controller 114 as a YUV signal with the second resolution (720×480) intact.

On the other hand, as shown in (b) in FIG. 8, graphics information 202A generated in the graphics controller 114 has the second resolution (720×480), for example. The graphics information 202A is scaled down to a third resolution (700×400), for example, by a scaling processing function of the graphics controller 114. The reduction ratio at this time can be determined by referencing the resolution (size) of the video information 201A and the size of the viewer-oriented information 201B, for example. The reduction ratio may be set fixedly or may be set or changed in response to the video information display size specified by the user through a setting screen. Graphics information 202B scaled down to the third resolution (700×400) is sent to the high quality video engine (HVE) 115 as an RGB signal.

As shown in (c) in FIG. 8, the high quality video engine (HVE) 115 performs alpha blending processing of the video information 201A having the second resolution (720×480) and the graphics information 202B having the third resolution (700×400). Video information 203A with a still image 203B subjected to alpha blending processing is generated in an area except an overscan area 203C.

As shown in (d) in FIG. 8, the video information 203A generated by the alpha blending processing is scaled up by the scaling processing function of the high quality video engine (HVE) 115 at enlargement ratio from the third resolution (700×400) to the first resolution (1024×768) (enlargement ratio larger than general enlargement ratio) As a result, the resolution of the video information 204A after scaled up becomes larger than the resolution (1024×768) of the screen of the LCD 17. Graphics information 204B after scaled up matches the resolution (1024×768) of the screen of the LCD 17.

The enlargement ratio satisfying the condition to scale up the video information 203A to the video information 204A is the enlargement ratio for causing an overscan area 204C in the video information 204A to overflow the resolution of the LCD screen. That is, it is the enlargement factor at which the size of an area 204B which is not the overscan area 204C in the video information 204A roughly matches the size of the screen of the LCD 17. As the video information 203A is scaled up to the video information 204A at the enlargement ratio, the viewer eyes do not fall on the overscan area 204C and fall on the area 204B which is not the overscan area 204C in the video information. In the example in (d) in FIG. 8, the size of the still image after scaled up roughly matches the size of the screen of the LCD 17.

The size of the overscan area is not definitely determined; it is desirable that the width of the area off the screen on which the viewer eyes do not fall should be set to about 20 dots in the horizontal direction and about 40 lines in the vertical direction, for example.

The image data generated by performing the processing in FIG. 8 is displayed on the LCD 17 in the form as shown above in FIG. 5B, for example.

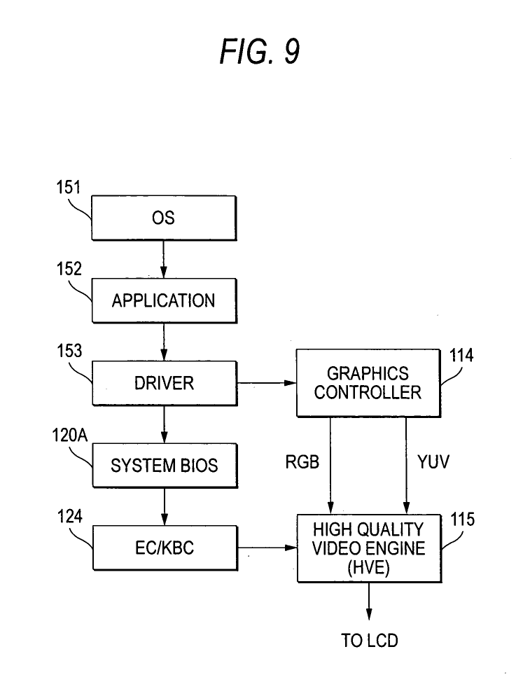

FIG. 9 is a drawing to show an example of an interface for appropriately displaying video information (moving image data) and graphics information (still image data) on the screen of the LCD 17.

An OS 151 manages an application 152, etc., and can send a notification of the desktop screen size (corresponding to the LCD screen size), etc., as required.

The application 152 can acquire the resolution (size) of the LCD screen from the OS 151, etc., can acquire the resolution (size) of video information and the resolution (size) of graphics information, and can acquire information specified by the user on a predetermined setting screen (information indicating the user specifies which of a limitation mode (first mode) to suppress displaying the surrounding portion (containing an overscan area) in video information on the LCD screen and a non-limitation mode (second mode) to display the surrounding portion, information specifying the range of a moving image not to be displayed on the LCD screen, etc.,).

The application 152 can determine the reduction ratio of scaling processing to be performed in the graphics controller 114, the enlargement ratio of scaling processing of video information (and still image information) to be performed in the high quality video engine (HVE) 115, etc., can control the graphics controller 114 through a driver 153 so as to perform scaling processing of graphics information at the determined reduction ratio, and can control the high quality video engine (HVE) 115 through system BIOS 120A and the EC/KBC 124 so as to perform scaling processing of video information at the determined enlargement ratio. Further, the application 152 may be designed to determine the mask range to mask video information and control the high quality video engine (HVE) 115 through the system BIOS 120A and the EC/KBC 124 so as to perform masking processing in the mask range.

The driver 153 can control the graphics controller 114 in accordance with a command from the application 152 and can start a specific function of the system BIOS 120A. For example, the driver 153 sets the reduction ratio or the enlargement ratio of the scaling processing of graphics information in the graphics controller 114. When graphics information to be alpha-blended into video information exists, the graphics information may be scaled down to a predetermined resolution.

The graphics controller 114 not only can send video information to the high quality video engine (HVE) 115 as a YUV signal, but also can send the graphics information to be alpha-blended into the video information to the high quality video engine (HVE) 115 as an RGB signal. The graphics controller 114 can also perform scaling processing of graphics information at the reduction ratio set by the driver 153 before sending the graphics information to the high quality video engine (HVE) 115.

When the system BIOS 120A is called from the driver 153, it starts a specific function and sets information indicating the enlargement ratio of scaling processing of video information (and still image information) to be performed in the high quality video engine (HVE) 115 in a predetermined register of the EC/KBC 124. Further, the system BIOS 120A may be designed to set information indicating the mask range to perform masking processing of video information in a predetermined register of the EC/KBC 124.

When information concerning the high quality video engine (HVE) 115 is set in a predetermined register of the EC/KBC 124, the EC/KBC 124 sets information indicating the enlargement ratio of scaling processing of video information (and still image information) in the scaling register 205 of the high quality video engine (HVE) 115. Further, the EC/KBC 124 may be designed to set information indicating the mask range to perform masking processing of video information in a predetermined register of the high quality video engine (HVE) 115.

The high quality video engine (HVE) 115 performs scaling processing for the input video information at the enlargement ratio set in the scaling register 205 and displays the post-processed video information on the LCD 17. In this case, the resolution of the video information after subjected to the scaling processing becomes larger than the resolution of the screen of the LCD 17. Particularly, the overscan area overflows the screen of the LCD 17 and the size of user-oriented information roughly matches the size of the screen of the LCD 17.

When not only the video information, but also the graphics information subjected to the scaling down processing in the graphics controller 114 is input to the high quality video engine (HVE) 115, the high quality video engine (HVE) 115 alphas-blends the graphics information into the video information and then performs scaling processing at the enlargement ratio set in the scaling register 205, for example.

When graphics information not subjected to the scaling down processing by the graphics controller 114 is input to the high quality video engine (HVE) 115, the high quality video engine (HVE) 115 may perform scaling processing of video information and the graphics information at different enlargement ratios. At this time, a modification may be made so as to perform alpha blending processing after the scaling processing. In this case, however, the resolution of the video information after subjected to the scaling processing is made larger than the resolution of the screen of the LCD 17 (particularly, the overscan area is made to overflow the screen of the LCD 17 and the size of user-oriented information is made to roughly match the size of the screen of the LCD 17) and the resolution of the graphics information after subjected to the scaling processing is made to fall within the resolution of the screen of the LCD 17. (The resolution of the graphics information after subjected to the scaling processing may be larger than the resolution of the screen of the LCD 17 in some cases.).

When graphics information not subjected to the scaling down processing in the graphics controller 114 is input, scaling processing of the graphics information and video information from which the surrounding portion (the portion corresponding to the overscan area) is excluded may be performed at different enlargement ratios. In this case, however, the resolution of the video information after subjected to the scaling processing is made to match the resolution of the screen of the LCD 17 and the resolution of the graphics information after subjected to the scaling processing is made to fall within the resolution of the screen of the LCD 17. (The resolution of the graphics information after subjected to the scaling processing may be larger than the resolution of the screen of the LCD 17 in some cases.)

When graphics information not subjected to the scaling down processing in the graphics controller 114 is input, masking processing may be performed for the surrounding portion in input video information based on the mask range information set in the predetermined register before scaling processing of the graphics information and the video information is performed. In this case, the resolution of the video information containing the mask portion after subjected to the scaling processing is made to match the resolution of the screen of the LCD 17 and the resolution of the graphics information after subjected to the scaling processing is made to fall within the resolution of the screen of the LCD 17. (The resolution of the graphics information after subjected to the scaling processing may be larger than the resolution of the screen of the LCD 17 in some cases.)

When the parameters of the enlargement ratio, the reduction ratio, etc., used for the scaling processing are fixed values, processing of setting or changing the parameters dynamically through the OS 151, the application 152, the driver 153, the system BIOS 120A, the EC/KBC 124, etc., shown in FIG. 9 becomes unnecessary (similar description applies when the parameters used for the masking processing are fixed values).

The software specifications may be changed for setting the resolution of generated graphics information smaller than the resolution of video information. For example, the resolution 720×480 is set to 700×400. Alternatively, the application 152 may transfer information to and from the OS 151 assuming that the resolution of graphics information is 720×480, and may transfer information to and from the driver 153 assuming that the resolution of graphics information is 700×400. In doing so, the graphics information scaling down processing in the graphics controller 114 becomes unnecessary.

By the way, how much noise appears in the overscan area varies depending on various conditions. The mentality for the overscan area varies largely from one video producer to another; the mentality largely differs making a comparison between the age in which video display means was almost limited to a CRT TV receiver and the future. Considering such a point, it is desirable that the user should be allowed to specify the display suppression range on the screen of the LCD 17.

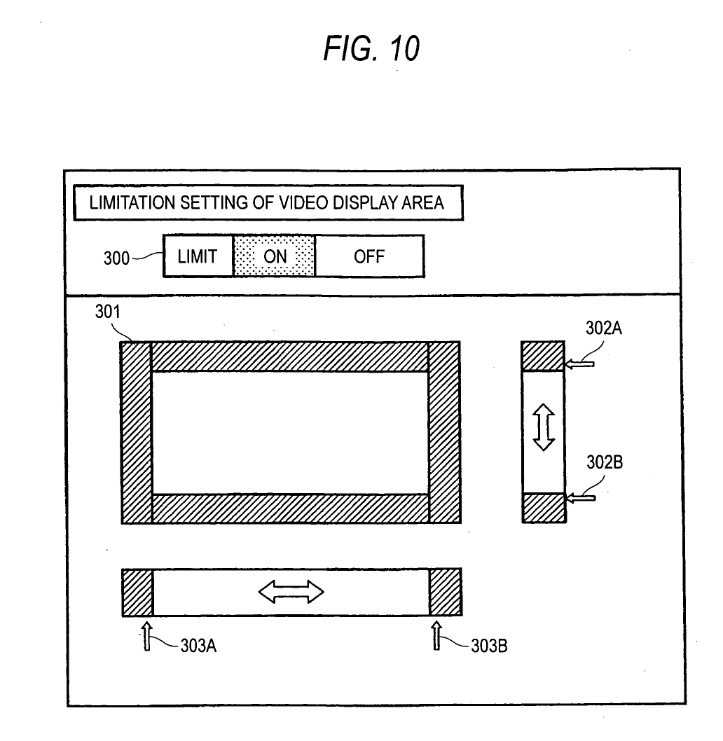

FIG. 10 is a drawing to show an example of a setting screen provided by the application for enabling the user to specify the display suppression range (containing the overscan area) on the screen of the LCD 17.

The setting screen shown in the figure is a screen for the user to make setting concerning display limitation in displaying video information on the LCD 17.

Provided at the top of the setting screen is a set item 300 for the user to specify one of a limitation mode to limit video information display (namely, to display only the area of viewer-oriented information and not to display the overscan area) and a non-limitation mode not to limit video information display (namely, to display both the area of viewer-oriented information and the overscan area). The set item 300 is provided with an ON area and an OFF area. When the user clicks on the ON area, the limitation mode is set; when the user clicks on the OFF area, the non-limitation mode is set.

Provided in the lower portion of the setting screen is an area for the user to specify the area range to limit video information display in the limitation mode when the user clicks on the ON area. In the area, the user cannot make setting in the non-limitation mode and can make setting in the limitation mode.

A rectangular area 301 in the lower portion of the setting screen represents the whole displayed video information. The hatched area in the area 301 represents an area containing the overscan area to be non-displayed, which will be hereinafter referred to as “non-display area.” The inner area represents an area to be displayed, which will be hereinafter referred to as “display area.”

Provided in the lower portion of the setting screen are a first control bar for controlling the width of the non-display area positioned at the top and the bottom of the area 301 and a second control bar for controlling the width of the non-display area positioned at the left and the right of the area 301. One-way arrows 302A and 302B attached to the first control bar and one-way arrows 303A and 303B attached to the second control bar indicate the boundary between the non-display area and the display area.

When the user clicks on the portion of the two-way arrow in each control bar, the width of the display area is widened one bit at a time or one line at a time in both directions (at this time, the one-way arrows also move). When the user clicks on the portion of the two-way arrow in each control bar with a Ctrl key pressed, the width of both sides of the non-display area is widened one bit at a time or one line at a time in both directions (at this time, the one-way arrows also move). As the user drags each of the one-way arrows 302A, 302B, 303A, and 303B, the four boundary lines between the non-display area and the display area can be moved separately.

The settings made on the setting screen are acquired by the application 152 and are used to determine the enlargement ratio, the reduction ratio in various types of scaling processing or determine the mask range in masking processing, etc.

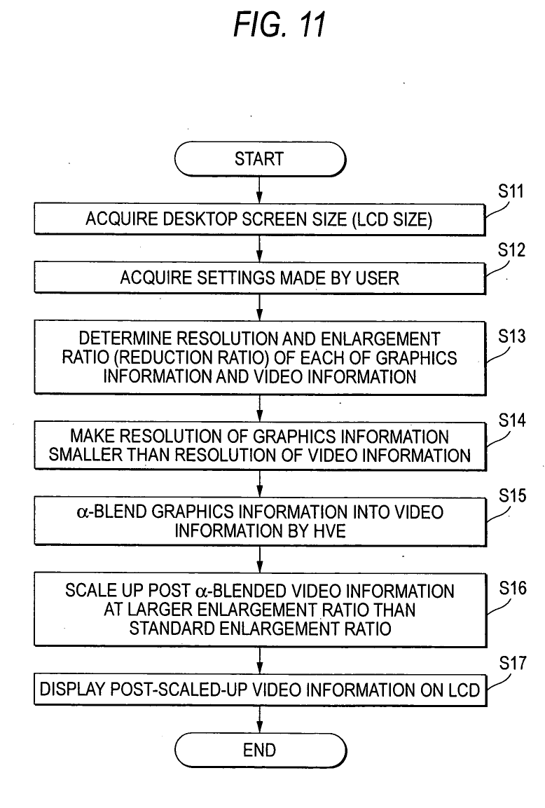

Next, an example of the operation of display control processing will be discussed with reference to a flowchart of FIG. 11 (also with reference to other drawings of FIG. 9, etc., as required).

The application 152 acquires the desktop screen size (1024×768) corresponding to the screen size of the LCD 17 from the OS 151 (step S11) and also acquires information set by the user on the setting screen (the size of the display area (for example, 700×480) or the size of the non-display area). (step S12).

The application 152 recognizes the resolution of graphic information (720×480) and the resolution of video information (720×480) based on the specifications, determines the reduction ratio of scaling processing performed in the graphics controller 114, the enlargement ratio of scaling processing of video information and still image information performed in the high quality video engine (HVE) 115, etc., based on various acquired information pieces, controls the graphics controller 114 through the driver 153 so as to perform scaling processing of graphics information at the determined reduction ratio, and sets the scaling parameter in the scaling register 205 of the high quality video engine (HVE) 115 through the system BIOS 120A and the EC/KBC 124 so as to perform scaling processing of video information at the determined enlargement ratio (step S13).

The driver 153 controls the graphics controller 114 in accordance with a command from the application 152 so as to scale down graphics information in the graphics controller 114 (graphics information to be alpha-blended into video information) to a predetermined resolution (for example, 700×400). The reduction ratio at this time can be determined by referencing the resolution (size) of the video information and the size of the viewer-oriented information, for example. Accordingly, the graphics controller 114 scales down the resolution of the graphic information to 700×400 (step S14).

The graphics information with the resolution scaled down to 700×400 is sent from the graphics controller 114 to the high quality video engine (HVE) 115. The video information with the resolution 720×480 is also sent to the high quality video engine (HVE) 115.

The high quality video engine (HVE) 115 alpha-blends the input graphics information into the input video information (step S15) and performs scaling processing of the video information after subjected to the alpha blending processing at the enlargement ratio set in the scaling register 205 (step S16).

The enlargement ratio at this time corresponds to the ratio for scaling up from the resolution 700×400 to the resolution 1024×768, for example, (in this case, the enlargement ratio is larger than the standard enlargement ratio for scaling up from the resolution 720×480 to the resolution 1024×768).

The video information thus subjected to the scaling processing is displayed on the screen of the LCD 17 (step S17).

As a result, the resolution of the displayed video information becomes larger than the resolution of the screen of the LCD 17. Particularly, the overscan area overflows the screen of the LCD 17 and the size of the user-oriented information roughly matches the size of the screen of the LCD 17.

When the user clicks on the OFF area to set the non-limitation mode on the setting screen shown in FIG. 10, control for changing the processing sequence described above becomes necessary. In this case, setting change of various types of processing is made so as to perform scaling processing of video information at the standard enlargement ratio for scaling up from the resolution 720×480 to the resolution 1024×768 in the high quality video engine (HVE) 115 without performing scaling processing of scaling down graphics information under the control of the application 152, etc.

According to the example described above, it is efficiently made possible for user eyes not to fall on the overscan area without performing masking processing, etc. In the high quality video engine (HVE) 115, the common enlargement ratio can be used for scaling processing of video information and graphics information, so that the development cost and the manufacturing cost of the high quality video engine (HVE) 115, etc., can be reduced.

### MODIFITED EXAMPLE 1

Next, a modified example of the operation will be discussed. In the modified example, the need for the scaling down processing of the graphics information in the graphics controller 114 can be eliminated. That is, the processing at step S14 previously described with reference to FIG. 11 becomes unnecessary. Instead, the graphics information and the video information are input to the high quality video engine (HVE) 115 at the same resolution (720×480) and thus the processing at steps S15 and S16 change.

For example, the high quality video engine (HVE) 115 performs scaling processing of the graphics information and video information from which the surrounding portion (the portion corresponding to the overscan area) is excluded at different enlargement ratios and then performs alpha blending processing. In this case, however, the resolution of the video information excluding the overscan area after subjected to the scaling processing is made to match the resolution of the screen of the LCD 17 and the resolution of the graphics information after subjected to the scaling processing is made to fall within the resolution of the screen of the LCD 17. (The resolution of the graphics information after subjected to the scaling processing may be larger than the resolution of the screen of the LCD 17 in some cases.) At this time, the enlargement ratio for the video information is set to the ratio for scaling up from the resolution 700×400 to the resolution 1024×768, for example. On the other hand, the enlargement ratio for the graphics information is set to the ratio for scaling up from the resolution 720×480 to the resolution 1024×768, for example.

As a result, the resolution of the video information excluding the overscan area roughly matches the resolution of the screen of the LCD 17, and the size of the user-oriented information roughly matches the size of the screen of the LCD 17.

When the user clicks on the OFF area to set the non-limitation mode on the setting screen shown in FIG. 10, control for changing the processing sequence described above becomes necessary. In this case, setting change of various types of processing is made so as to perform scaling processing of graphics information and video information (video information with the surrounding portion (the portion corresponding to the overscan area)) at the standard enlargement ratio for scaling up from the resolution 720×480 to the resolution 1024×768 in the high quality video engine (HVE) 115 under the control of the application 152, etc.

According to the example described above, the need for the scaling down processing of the graphics information in the graphics controller 114 can be eliminated. It is efficiently made possible for user eyes not to fall on the overscan area without performing masking processing, etc.

### MODIFIED EXAMPLE 2

Next, a modified example of the operation will be discussed. Also in the modified example, the need for the scaling down processing of the graphics information in the graphics controller 114 can be eliminated. That is, the processing at step S14 previously described with reference to FIG. 11 becomes unnecessary. Instead, the graphics information and the video information are input to the high quality video engine (HVE) 115 at the same resolution (720×480) and thus the processing at steps S15 and S16 change.

For example, the high quality video engine (HVE) 115 performs masking processing for the surrounding portion (the portion corresponding to the overscan area) in the video information and then performs alpha blending processing and performs scaling processing. In this case, however, the resolution of the video information (containing the mask portion) after subjected to the scaling processing is made to match the resolution of the screen of the LCD 17 and the resolution of the graphics information after subjected to the scaling processing is made to roughly match the resolution of the screen of the LCD 17. At this time, the enlargement ratio used for the scaling processing is set to the standard ratio for scaling up from the resolution 720×480 to the resolution 1024×768.

As a result, the resolution of the video information containing the mask portion roughly matches the resolution of the screen of the LCD 17, and the size of the user-oriented information roughly matches the size of the screen of the LCD 17.

When the user clicks on the OFF area to set the non-limitation mode on the setting screen shown in FIG. 10, control for changing the processing sequence described above becomes necessary. In this case, setting change of various types of processing is made so as to perform the standard scaling processing described above without performing masking processing (with masking processing released).

According to the example described above, the scaling down processing of the graphics information in the graphics controller 114 can be made unnecessary. The standard enlargement ratio can be used in the scaling processing of the high quality video engine (HVE) 115 and can be set to a fixed value.

The graphics controller 114 and the high quality video engine (HVE) 115 can also be implemented in one LSI. In this case, the graphics controller 114 and the high quality video engine (HVE) 115 function as two signal processing sections in the LSI.

In the embodiment, the case where the information processing apparatus is a personal computer is illustrated, but the invention is not limited to it and can also be applied to other machines such as a PDA and a mobile telephone.

In the embodiment, the resolution of the screen of the display is larger than the resolution of graphics information and that of video information and therefore scaling processing of scaling up an image is performed in the high quality video engine (HVE) 115. When the screen of the display of the information processing apparatus incorporating the invention is small (as with a mobile telephone, etc.,), scaling processing of scaling down an image rather than scaling up processing needs to be performed.

It is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An information processing apparatus comprising:
a display being capable of displaying moving image data having a predetermined outer peripheral area, the display having a first resolution;
a moving image data generating section that generates the moving image data having a second resolution;
a first scaling section that performs scaling processing so that an area except the predetermined outer peripheral area in the moving image data having the second resolution substantially matches the first resolution; and
a displaying section that causes the display to display the area except the predetermined outer peripheral area in the moving image data subjected to the scaling processing by the first scaling section.

2. The information processing apparatus as claimed in claim 1, further comprising an image quality processing section that performs image quality processing for the moving image data having the second resolution;
wherein the first scaling section performs scaling processing for the moving image data having the second resolution, subjected to the image quality processing by the image quality processing section.

3. The information processing apparatus as claimed in claim 1, wherein the display is capable of displaying still image data, the information processing apparatus further comprising:
a second scaling section that performs scaling processing so that the still image data falls within the size of the area except the predetermined outer peripheral area in the moving image data having the second resolution; and
a superposing section that superposes the still image data subjected to the scaling processing by the second scaling section on the moving image data;
wherein the first scaling section performs scaling processing for the moving image data on which the still image data subjected to the scaling processing by the second scaling section is superposed.

4. An information processing apparatus comprising:
a display being capable of displaying a moving image and a still image, and having a first resolution;
a moving image data generating section that generates moving image data having a second resolution;
a still image data generating section that generates still image data having a predetermined resolution;
a superposing section that superposes the still image data on the moving image data;
a scaling section that performs scaling processing of the moving image data and the still image data at a ratio for scaling up or down from the second resolution or the predetermined resolution to the first resolution; and
a displaying section that causes the display to display the moving image data and the still image data subjected to the scaling processing by the scaling section.

5. The information processing apparatus as claimed in claim 4, wherein the predetermined resolution of the still image data generated by the still image data generating section is smaller than the second resolution of the moving image data; and
the scaling section performs scaling processing of the moving image data and the still image data at a ratio for scaling up the predetermined resolution to the first resolution.

6. The information processing apparatus as claimed in claim 5, further comprising:
a selection section that allows a user to select one of a first mode to suppress displaying a surrounding portion of the moving image on the display and a second mode to display the surrounding portion; and
a setting change section that changes processing setting when the user selects the second mode so as to generate still image data of the substantially same resolution as the second resolution and to perform scaling processing of the moving image data and the still image data at a ratio for scaling up or down from the second resolution to the first resolution.

7. The information processing apparatus as claimed in claim 5, further comprising:
a specifying section that allows a user to specify a range of the moving image not to be displayed on the display; and
a determining section that determines the predetermined resolution of the still image data in response to the specified range.

8. The information processing apparatus as claimed in claim 4, wherein the predetermined resolution of the still image data generated by the still image data generating section is the substantially same as the second resolution of the moving image data; and
the scaling section performs scaling processing of the still image data at a ratio for scaling up or down from the second resolution to the first resolution and performs scaling processing of moving image data of a third resolution excluding a surrounding portion of the moving image data of the second resolution at a ratio for scaling up or down from the third resolution to the first resolution.

9. The information processing apparatus as claimed in claim 8, further comprising:
a selection section that allows a user to select one of a first mode to suppress displaying the surrounding portion of the moving image data on the display and a second mode to display the surrounding portion; and
a setting change section that changes processing setting when the user selects the second mode so as to perform scaling processing of the moving image data of the second resolution at a ratio for scaling up or down from the second resolution to the first resolution.

10. The information processing apparatus as claimed in claim 8, further comprising:
a specifying section that allows a user to specify a range of the moving image not to be displayed on the display; and
a determining section that determines the third resolution of the moving image data in response to the specified range.

11. The information processing apparatus as claimed in claim 4, further comprising a mask section that performs mask processing of a surrounding portion of the moving image data;
wherein the predetermined resolution of the still image data generated by the still image data generating section is the substantially same as the second resolution of the moving image data; and
the scaling section performs scaling processing of the moving image data subjected to the mask processing and the still image data at a ratio for scaling up or down from the second resolution to the first resolution.

12. The information processing apparatus as claimed in claim 11, further comprising:
a selection section that allows a user to select one of a first mode to suppress displaying the surrounding portion of the moving image data on the display and a second mode to display the surrounding portion; and
a mask canceling section that cancels the mask processing when the user selects the second mode.

13. The information processing apparatus as claimed in claim 11, further comprising:
a specifying section that allows a user to specify a range of the moving image not to be displayed on the display; and
a determining section that determines a range of the mask processing for the moving image data in response to the specified range.

14. The information processing apparatus as claimed in claim 4, further comprising an image processing controller being capable of performing image processing for the moving image data and the still image data;
wherein the image processing controller contains the scaling section.

15. A display control method for use in an information processing apparatus being capable of displaying a moving image and a still image on a display having a first resolution, the display control method comprising:
generating moving image data of a second resolution;
generating still image data of a predetermined resolution;
superposing the still image data on the moving image data; and
performing scaling processing of the moving image data and the still image data at a ratio for scaling up or down from the second resolution or the predetermined resolution to the first resolution; and
outputting the data to the display.

16. The display control method as claimed in claim 15, wherein the predetermined resolution of the still image data generated during the generating still image data is smaller than the second resolution of the moving image data; and
during the performing scaling processing, scaling processing is performed on the moving image data and the still image data at a ratio for scaling up or down from the predetermined resolution to the first resolution.

17. The display control method as claimed in claim 15, wherein the predetermined resolution of the still image data generated during the generating still image data is the same as the second resolution of the moving image data; and
during the performing scaling processing, scaling processing is performed on the still image data at a ratio for scaling up or down from the second resolution to the first resolution and is performed on the moving image data of a third resolution excluding a surrounding portion of the moving image data of the second resolution at a ratio for scaling up or down from the third resolution to the first resolution.

18. The display control method as claimed in claim 15, further comprising:
performing mask processing of a surrounding portion of the moving image data;
wherein the predetermined resolution of the still image data generated during the generating still image data is the same as the second resolution of the moving image data; and
during the performing scaling processing, scaling processing is performed on the moving image data subjected to the mask processing and the still image data at a ratio for scaling up or down from the second resolution to the first resolution.
